(19) United States
(12) Patent Application Publication
(10) Pub. No.: US 2021/0108985 A1
(43) Pub. Date: Apr. 15, 2021

(54) Rotary Tool Diagnostic With Acoustic Chamber

(71) Applicant: Robert Bosch GmbH, Stuttgart (DE)

(72) Inventor: Jamie Moreno Terrazas, Imperial, CA (US)

(21) Appl. No.: 16/596,923

(22) Filed: Oct. 9, 2019

(51) Int. Cl. G01M 7/02; G01M 5/00

(52) U.S. Cl. CPC G01M 7/025; G01M 5/0033; G01M 5/0066

(57) ABSTRACT

A system and method for performing diagnostics of a power tool, such as a rotary tool, based upon measurements of acoustic patterns of the tool under test during active operation. An active profile associated with the tool under test may be generated and compared to reference profiles, each of the reference profiles being associated with a known operating condition, to yield an assessment of the operating condition of the tool under test. In some embodiments, a processor may utilize the diagnostics to update one or more of the reference profiles after the diagnostic is complete.

### TECHNICAL FIELD

This disclosure relates to diagnostic of power tools, and in particular rotary tools.

### BACKGROUND

Manufactured power tools can be built quickly and efficiently. Testing of power tools may be required to ensure the tools are manufactured with a consistent desired quality. Testing of different functions of power tools may be useful to ensure consistent quality across a broad range of intended operations.

Testing of multiple operational modes may take more time than is desirable, and may constitute a substantial slow-down in the production during manufacture.

### SUMMARY

One aspect of this disclosure is directed to a diagnostic system for a rotary tool, the system comprising a processor, a memory in data communication with the processor, an acoustic transducer in data communication with the processor, and a chamber configured to at least partially-surround the acoustic transducer. The processor may be configured to receive acoustic data corresponding to acoustic vibrations within the chamber while the rotary tool is active, and then designate an operating condition of the rotary tool. The received acoustic data may be compared to reference acoustic data in preparing the designation.

Another aspect of this disclosure is directed to a method of performing a rotary tool diagnostic, the method comprising activating a rotary tool within a chamber, generating an active profile of the rotary tool and designating an operation condition of the rotary tool based upon the active profile. The active profile may be generated based upon acoustic data generated within the chamber. The designation may be accomplished based upon a comparison of the active profile to a number of reference profiles, each of the reference profiles associated with a known operating condition of a rotary tool.

A further aspect of this disclosure is directed to a non-transitory computer-readable medium having instructions stored thereon which, when read by a processor, cause the processor to perform a method of a rotary tool diagnostic, the method comprising activating a rotary tool within a chamber, generating an active profile of the rotary tool and designating an operation condition of the rotary tool based upon the active profile. The active profile may be generated based upon acoustic data generated within the chamber. The designation may be accomplished based upon a comparison of the active profile to a number of reference profiles, each of the reference profiles associated with a known operating condition of a rotary tool.

The above aspects of this disclosure and other aspects will be explained in greater detail below with reference to the attached drawings.

### BRIEF DESCRIPTION OF THE DRAWINGS

FIG. 1 is a diagrammatic illustration of a system for performing a rotary tool diagnostic.

FIG. 2 is an illustration of a chamber for use in rotary tool diagnostics.

FIG. 3 is an illustration of a chamber for use in rotary tool diagnostics.

FIG. 4 is a flowchart showing the steps of a method of rotary tool diagnostics.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

Power tools may be directed to tasks that may be accomplished using bits or heads driven by a motor, such as cutting, drilling, polishing, grinding, or screwing. The teachings herein may be applicable to a variety of power tools, but for the purposes of illustration and not limitation the disclosure will be directed to rotary tools. Rotary tools utilize rotational motion for the tasks of the tool, often with interchangeable heads to accomplish different tasks. The motion of rotary tools may be particularly regular, permitting for testing that utilizes the highly-regular motion of the motor or head of the rotary tool. One of ordinary skill will recognize the utility of the teachings herein directed to other forms of power tools, such as screw guns, drills, saws, or any other tool having a motorized motion.

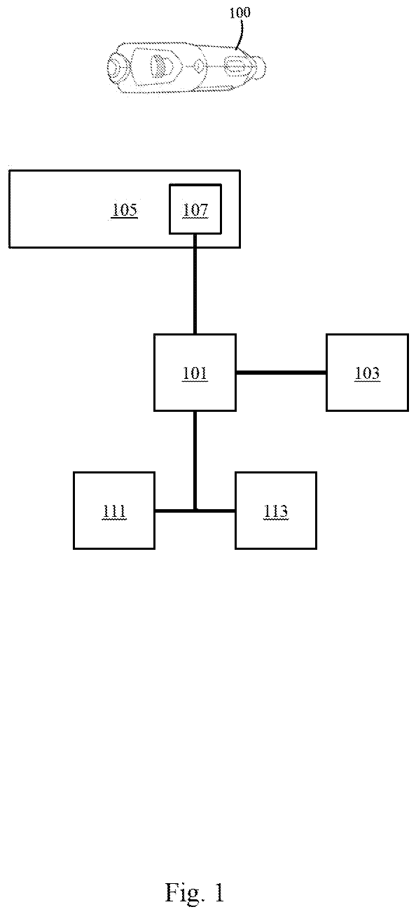

FIG. 1 is a diagrammatic illustration of a system that may be used for diagnostics directed to a rotary tool 100. In the depicted embodiment, rotary tool 100 may comprise an electrically-driven motor, but other embodiments may comprise other power sources without deviating from the teachings disclosed herein. In the depicted embodiment, rotary tool 100 may comprise a cordless model having a battery, but other embodiments may comprise other configurations without deviating from the teachings disclosed herein.

The system depicted in FIG. 1 may comprise a processor 101, a memory 103, and a chamber 105. The processor 101 may operable to read instructions to perform a method of rotary tool diagnostic. Chamber 105 may at least partially-surround an acoustic transducer 107. Acoustic transducer 107 is operable to generate acoustic data describing acoustic conditions for at least a portion of the environment within chamber 105. Chamber 105 may be configured to isolate the acoustic conditions within itself from the acoustic conditions outside of the chamber. In the depicted embodiment, acoustic transducer 107 may comprise a microphone, but other embodiments may comprise an audio sensor, a vibration sensor, a MEMS sensor, or any other suitable element recognized by one of ordinary skill in the art without deviating from the teachings disclosed herein. Acoustic transducer 107 may be directionally-sensitive or omnidirectional without deviating from the teachings disclosed herein. Acoustic transducer 107 is in data communication with processor 101, and processor 101 is operable to receive acoustic data generated by acoustic transducer 107. In some embodiments, processor 101 may be operable to send control signals or other data to acoustic transducer 107 without deviating from the teachings disclosed herein.

Processor 101 may be embodied as a tablet computer, but other embodiments may comprise a mobile processing device, a smartphone, a laptop computer, a wearable computing device, a desktop computer, a personal digital assistant (PDA) device, a handheld processor device, a specialized processor device, a system of processors distributed across a network, a system of processors configured in wired or wireless communication, or any other alternative embodiment known to one of ordinary skill in the at without deviating from the teachings disclosed herein.

Processor 101 is further in data communication with memory 103. Memory 103 may comprise a computer-readable medium with computer-readable instructions stored thereon that are readable by processor 101 to perform a method according to the instructions. Computer-readable instructions may include instructions and data which cause a general purpose computer, special purpose computer, or other processing device to perform a certain function or group of functions. Computer-readable instructions may also include program modules that are executed by computers in stand-alone or network environments. Program modules may include routines, programs, objects, components, or data structures that perform particular tasks or implement particular abstract data types. Computer-readable instructions, associated data structures, and program modules represent examples of the program code means for executing steps of the methods disclosed herein. The particular sequence of such executable instructions or associated data structures represents examples of corresponding acts for implementing the functions described in such steps.

Memory 103 may be embodied as a non-transitory computer-readable storage medium or a machine-readable medium for carrying or having computer-executable instructions or data structures stored thereon. Such non-transitory computer-readable storage media or machine-readable medium may be any available media embodied in a hardware or physical form that can be accessed by a general purpose or special purpose computer. By way of example, and not limitation, such non-transitory computer-readable storage media or machine-readable medium may comprise random-access memory (RAM), read-only memory (ROM), electrically erasable programmable read-only memory (EEPROM), optical disc storage, magnetic disk storage, linear magnetic data storage, magnetic storage devices, flash memory, or any other medium which can be used to carry or store desired program code means in the form of computer-executable instructions or data structures. Combinations of the above should also be included within the scope of the non-transitory computer-readable storage media or machine-readable medium.

Processor 101 may further be in data communication with a display 111 and a human-machine interface (HMI) 113. Display 111 and HMI 113 may be operable to provide a user, such as a technician or other tester of rotary tool 100, to interact with processor 101. In some embodiments, processor 101 may be integrated with one or both of display 111 and HMI 113, such as in a tablet computer with a touchscreen interface. Other embodiments may comprise other configurations without deviating from the teachings disclosed herein.

Diagnostic of rotary tool 100 may comprise a measurement of the acoustic conditions within chamber 105 to generate first acoustic data that establishes a baseline measurement of conditions for calibration purposes. After the baseline measurement is established, rotary tool 100 may be positioned at a designated point with respect to chamber 105. The designated point may be partially- or wholly-surrounded by chamber 105, in direct contact with a surface of chamber 105, or in a particular position with respect to chamber 105 without deviating from the teachings disclosed herein. After rotary tool 100 is positioned, it may be activated, and second acoustic data may be generated to establish a measurement of the active rotary tool 100. The difference between the second acoustic data and the first acoustic data may be utilized to generate an active profile of the rotary tool.

The active profile may be compared or contrasted to a number of reference profiles, each of the reference profiles associated with a known operating condition of a rotary tool having similar specification to rotary tool 100. By way of example, and not limitation, a known operating condition may comprise a specified rotational speed setting of the rotary tool, a particular attachment installed on the rotary tool, an age or length of operating-time of the rotary tool, a particular specification of one or more components of the rotary tool, a defect condition of the rotary tool, or any other operating condition recognized by one of ordinary skill in the art without deviating from the teachings disclosed herein. A defect condition may comprise any instance of sub-optimal operation of the tool. By way of example, and not limitation, a defect condition may comprise a rotational speed different than the selected rotational speed, an irregular rotation during operation, an irregular or improper power draw of the rotary tool, a condition of enhanced wear of one or more components of the rotary tool, a condition of corrosion of one or more components of the rotary tool, an obstruction or clog of one or more components of the rotary tool, a physical deformation of one or more components of the rotary tool, a lack of calibration of the rotary tool, or any other condition recognized by one of ordinary skill in the art to be a sub-optimal operating condition without deviating from the teachings disclosed herein. Other embodiments may comprise reference profiles having different or additional operating conditions without deviating from the teachings disclosed herein.

In the depicted embodiment, the reference profiles may be associated with complex conditions, wherein the operation of the rotary tool is sub-optimal for multiple reasons. By way of example, and not limitation, a complex condition may comprise any two or more of the above-listed sub-optimal conditions.

In the depicted embodiment, memory 103 may be configured to store a number of the reference profiles, but other embodiments may comprise other configurations without deviating from the teachings disclosed herein. The active profile and reference profiles may comprise a Fourier Transform of the acoustic data, such as a Fast Fourier Transform (FFT) or Discrete Fourier Transform (DFT), to provide a frequency spectrum of the associated rotary tool. The active profile and the reference profiles may be derived from measurements lasting a specified period of time. By way of example, and not limitation, the period of time for measurement may be less than 10 seconds.

In some embodiments, processor 101 may utilize display 111 or HMI 113 to guide a user (such as a technician) to position and activate rotary tools under test in order to optimize the efficiency of the diagnostic system for use with a plurality of rotary tools. By way of example, and not limitation, processor 100 may generate visual or audible prompts for a user to position the rotary tool, activate the rotary tool under a particular operational setting, deactivate the rotary tool, or remove the rotary tool from the specified position. In some embodiments, one or more of these steps may be automated without deviating from the teachings disclosed herein. In some embodiments, a user may utilize HMI 113 to confirm the completion of the task described in a prompt, but other embodiments may utilize a timer mechanism to present the prompts without interruption or response from the user. In some embodiments, processor 101 may be configured to continuously receive a stream of acoustic data from acoustic transducer 107, and utilize the user input or the timer mechanism to designate starting and stopping times for measurements within the stream of acoustic data.

During the diagnostic testing, the active profile may be compared and contrasted to each of the number of reference profiles to determine a best-match reference profile. Upon determination of a best-match reference profile, the operating condition of rotary tool 100 may be designated as the same as the operating condition associated with the best-match reference profile. A best-match reference profile may be determined by seeking a maximum correlation between one or more features of the active profile and each of the reference profiles, but other embodiments may comprise other algorithms without deviating from the teachings disclosed herein. In some embodiments, a specified threshold for similarity may be required to prevent a false designation of rotary tool 100. The specified threshold may be associated with one or more features of the active profile without deviating from the teachings disclosed herein. The specified threshold may be required to be satisfied by a minimum number of features of the active profile for a positive designation without deviating from the teachings disclosed herein.

In some embodiments, processor 101 may be operable to utilize machine learning to update reference profiles that have been designated as a best-match for the active profile. Such updates provide a degree of machine-learning that may improve the robustness of the diagnostic system against variables in the testing, such as environmental conditions (e.g., temperature, humidity, barometric pressure) that can affect acoustic data, or variability in component manufacture within the manufacturing thresholds. Each reference profile may comprise a weighted average of features corresponding to rotary tools having the associated operating condition. In some embodiments, the reference profile may comprise a “moving average” of a set number of the most-recent designations of that particular operating condition without deviating from the teachings disclosed herein. In some embodiments, the reference profile may comprise a “weighted average” of a number of past measurements without deviating from the teachings disclosed herein. The weighting of the number of past measurements may be adjusted based upon the amount of time that has passed since a particular measurement was obtained without deviating from the teachings disclosed herein. In some embodiments, the reference profile may comprise an average of all associated measurements during operation of the diagnostic system, and may improve the diagnostic system over time as the reference profiles are fine-tuned by the updates. In some embodiments, if the active profile is not sufficiently similar to any of the reference profiles to make a positive designation, a new reference profile may be generated corresponding to the operational condition of the rotary tool under test. In some embodiments, if the active profile is not sufficiently similar to any of the reference profiles to make a positive designation, the processor may generate an error indicator. Other embodiments may utilize other machine learning techniques without deviating from the teachings disclosed herein.

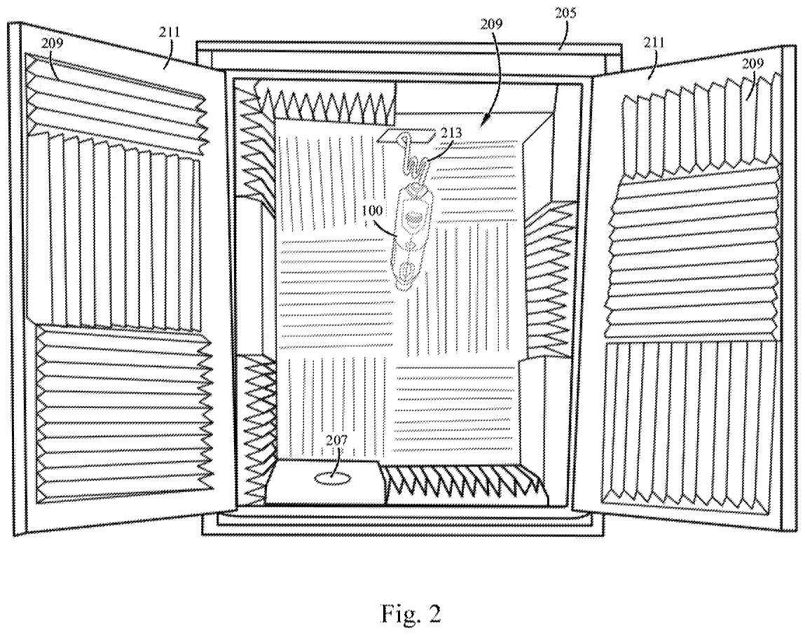

Different embodiments may comprise different configurations of chamber 105. FIG. 2 provides an illustration of one such configuration in the form of a chamber 205 that is configured to partially-surround rotary tool 100 during the diagnostic testing. In the depicted embodiment, an acoustic transducer 207 is additional partially-surrounded by chamber 205. Other embodiments may comprise other arrangements of acoustic transducer 207 without deviating from the teachings disclosed herein. In the depicted embodiment, chamber 205 comprises acoustic treatments 209 to isolate the interior of the chamber from the environment external to the chamber. In the depicted embodiment, acoustic treatments 209 comprise absorptive materials, but other embodiments may comprise insulation, reflective materials, or diffusive materials without deviating from the teachings disclosed herein. Other embodiments may comprise combinations of different forms of acoustic treatment, or no acoustic treatment without deviating from the teachings disclosed herein. In the depicted embodiment, chamber 205 comprises a number of doors 211 suitable to fully-surround rotary tool 100 during diagnostic testing, but other embodiments may comprise a different configuration having a different number of doors or no doors at all without deviating from the teachings disclosed herein. In the depicted embodiment, rotary tool 100 is suspended from the surfaces of chamber 205 via a mount 213. Mount 213 may be configured to isolate the surfaces of chamber 205 from any direct vibrations caused by rotary tool 100 during the diagnostic test, but other embodiments may comprise other configurations without deviating from the teachings disclosed herein. In the depicted embodiment, acoustic transducer 207 may comprise an omnidirectional microphone, but other embodiments may comprise other configurations without deviating from the teachings disclosed herein.

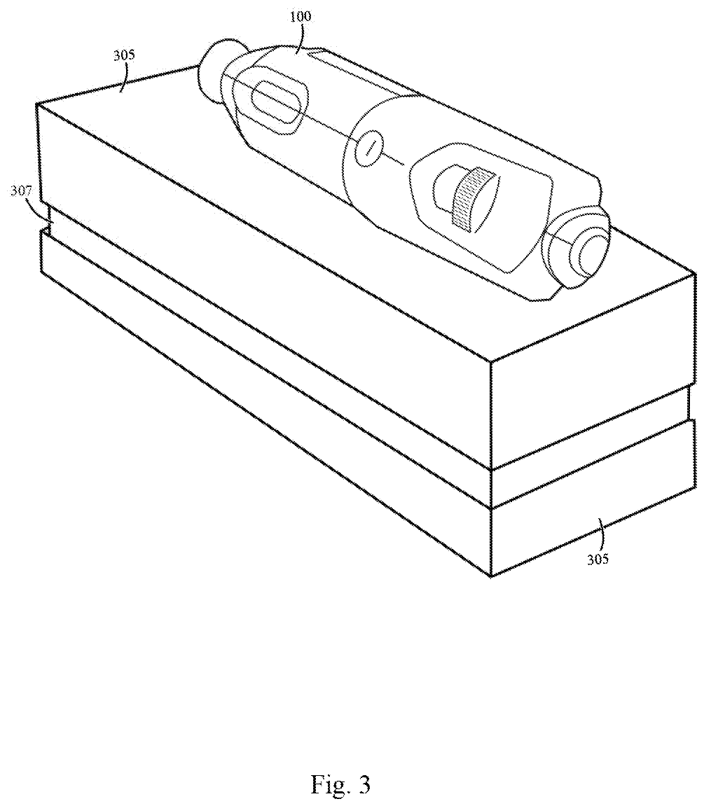

Some embodiments of a diagnostic system may utilize direct vibration of a rotary tool with a surface of the chamber. Direct vibration may be accomplished by at least partial contact of a surface of the chamber with the rotary tool under test. FIG. 3 depicts an embodiment in which a rotary tool 100 under test makes direct contact with the outer surfaces of a chamber 305 that partially surrounds an acoustic transducer 307. In the depicted embodiment, chamber 305 may be comprised of insulating materials to attenuate the vibrations of rotary tool 100, but other embodiments may comprise other configurations using different materials or material combinations without deviating from the teachings disclosed herein. The chamber 305 may advantageously provided for a fast changeover between diagnostic tests of different tools by providing easier setup and access to a rotary tool under test. In the depicted embodiment, acoustic transducer 307 is partially surrounded by chamber 305, but other embodiments may comprise other configurations without deviating from the teachings disclosed herein. In the depicted embodiment, acoustic transducer 307 may comprise a directional sensor, such as a boundary microphone, but other embodiments may comprise other configurations without deviating from the teachings disclosed herein.

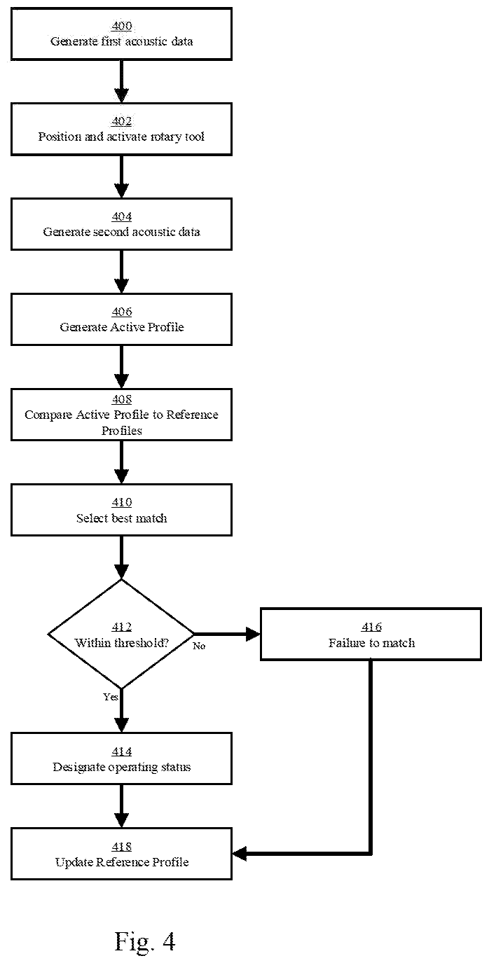

FIG. 4 is an flowchart of a method of operating a diagnostic system, such as the diagnostic system depicted in FIG. 1, according to one embodiment of the invention disclosed herein. The method begins at step 400 where first acoustic data is generated to determine a baseline measurement of conditions within a chamber. After a baseline measurement has been established, the method proceeds to step 402, where a rotary tool for testing is positioned and activated with one or more specified operational settings.

After positioning and activation of the rotary tool under test, the method proceeds to step 404, where second acoustic data is generated that corresponds to the environment within the chamber while the rotary tool is activated. The method then proceeds to step 406, where the first acoustic data and second acoustic data are utilized to generate an active profile corresponding to the rotary tool. The active profile may comprise one or more features defining the acoustic properties of the chamber while the rotary tool is activated with the specified operational settings. Such features may include features associated with a spectral representation of the acoustic properties, such as those obtained by an FFT. Such features may additionally be associated with a specified timeframe of operation.

Once an active profile has been generated, the method proceeds to step 408, where the active profile may be compared to one or more reference profiles, wherein each of the reference profiles is associated with a specified operating condition of a rotary tool. In some embodiments, one or more reference profiles may be associated with a complex operating condition, wherein one or more operating conditions are associated with the reference profile in combination. After a comparison has been completed, a best match is selected at step 410.

At step 412, the match of the active profile and the best match is considered to ensure that the match meets one or more threshold requirements with respect to one or more features of the profiles. If the match satisfies the threshold requirement, the method proceeds to step 414. If the match does not satisfy the threshold requirement, the method may proceed to step 416 instead, where a failure condition is noted. If the method reaches step 414, the best match reference profile may be updated in response to the designation at step 418 using the features of the active profile.

In the depicted embodiment, if the method reaches step 416, the method may proceed to step 418 to update the reference profiles by generating a new reference profile for future diagnostic testing. Other embodiments may provide a transition from step 416 to step 418 without deviating from the teachings disclosed herein. Some embodiments may not comprise step 418 without deviating from the teachings disclosed herein.

In some embodiments, the method of FIG. 4 may be directed by a processor providing prompts to a user, such as visual or audible prompts. In some such embodiments, the method may proceed to the next step of the method in response to user input from a human-machine interface indicating that the current step has been completed.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A diagnostic system for a rotary tool, the diagnostic system comprising:
a processor;
a memory in data communication with the processor;
an acoustic transducer in data communication with the processor and operable to generate acoustic data; and
a chamber configured to at least partially-surround the acoustic transducer, wherein
the acoustic transducer is configured to generate acoustic data corresponding to acoustic vibrations within the chamber during operation of a rotary tool, and the processor is configured to receive the acoustic data and generate an active profile corresponding to the rotary tool, wherein the memory is configured to store a number of reference profiles, each of the number of reference profiles associated with a known operating condition of a rotary tool, and wherein the processor is further operable to designate an operating condition of the rotary tool based upon the active profile.

2. The diagnostic system of claim 1, wherein the operating condition of each of the number of reference profiles comprises a rotational speed of an associated rotary tool.

3. The diagnostic system of claim 1, wherein the operating condition of at least one of the number of reference profiles comprises a defect condition of the rotary tool.

4. The diagnostic system of claim 1, wherein the active profile and each of the number of reference profiles comprises a Fourier Transform.

5. The diagnostic system of claim 1, wherein at least one of the number of reference profiles is updated in response to designating an operating condition of the rotary tool.

6. The diagnostic system of claim 1, wherein the chamber is configured to at least partially surround the rotary tool.

7. The diagnostic system of claim 1, wherein the chamber is configured to be in at least partial contact with the rotary tool.

8. The diagnostic system of claim 1, wherein the processor is configured to continuously receive acoustic data from the acoustic transducer.

9. A method of performing a rotary tool diagnostic, the method comprising:
generating first acoustic data describing acoustic conditions within a chamber;
activating a rotary tool such that the rotary tool transmits vibration within the chamber;
generating second acoustic data describing the acoustic conditions within the chamber during the activation of the rotary tool;
generating an active profile of the rotary tool corresponding to a difference between the second acoustic data and the first acoustic data; and
designating an operating condition of the rotary tool based upon a comparison of the active profile to a number of reference profiles, each reference profile associated with a known operating condition of a rotary tool,
wherein the number of reference profiles are stored in a memory and accessible during the comparison by a processor in data communication with the memory.

10. The method of claim 9, wherein the active profile and each of the number of reference profiles comprises a Fourier Transform.

11. The method of claim 9, further comprising a step of updating at least one of the number of reference profiles in response to the designating an operating condition of the rotary tool.

12. The method of claim 9, wherein the activating the rotary tool further comprises bringing the rotary tool into at least partial contact with a surface of the chamber.

13. The method of claim 9, wherein the operating condition of each of the number of reference profiles comprises a rotational speed of an associated rotary tool.

14. The method of claim 9, wherein the operating condition of at least one of the number of reference profiles comprises a defect condition of the rotary tool.

15. A non-transitory computer-readable storage medium having executable instructions thereon that, when executed by a processor, cause the processor to perform a method comprising:
generating first acoustic data describing acoustic conditions within a chamber;
activating a rotary tool such that the rotary tool transmits vibration within the chamber;
generating second acoustic data describing the acoustic conditions within the chamber during the activation of the rotary tool;
generating an active profile of the rotary tool corresponding to a difference between the second acoustic data and the first acoustic data; and
designating an operating condition of the rotary tool based upon a comparison of the active profile to a number of reference profiles, each reference profile associated with a known operating condition of a rotary tool.

16. The non-transitory computer-readable storage medium of claim 15, further comprising a portion thereof storing the number of reference profiles, the portion being accessible by the processor during the comparison of the active profile to the number of reference profiles.

17. The non-transitory computer-readable storage medium of claim 15, wherein the active profile and each of the number of reference profiles comprises a Fourier Transform.

18. The non-transitory computer-readable storage medium of claim 15, wherein the operating condition of each of the number of reference profiles comprises a rotational speed of an associated rotary tool.

19. The non-transitory computer-readable storage medium of claim 15, wherein the operating condition of at least one of the number of reference profiles comprises a defect condition of an associated rotary tool.

20. The non-transitory computer-readable storage medium of claim 15, further comprising instructions stored thereon that, when executed by a processor, cause the processor to perform the step of updating at least one of the number of reference profiles in response to the designating an operating condition of the rotary tool.
